(19) United States
(12) Patent Application Publication
(10) Pub. No.: US 2006/0090401 A1
(43) Pub. Date: May 4, 2006

(54) Air heated, flexible door panel

(75) Inventors: Curtis L. Berry, Williamsport, MD (US); William B. Nichols, Chambersburg, PA (US)

Correspondence Address: FROST BROWN TODD, LLC, 2200 PNC CENTER, 201 E. FIFTH STREET, CINCINNATI, OH, 45202, US

(73) Assignee: Jamison Door Company

(21) Appl. No.: 11/262,418

(22) Filed: Oct. 28, 2005

Related U.S. Application Data
(63) Continuation-in-part of application No. 10/339,822, filed on Jan. 10, 2003, now Pat. No. 6,983,565.
(60) Provisional application No. 60/717,311, filed on Sep. 15, 2005.

(51) Int. Cl. E05D 15/06

(52) U.S. Cl. 49/409

(57) ABSTRACT

A door system for a cold storage locker that includes resilient door panels that flex and have increased resistance to damage when hit by a forklift. A high degree of insulation is achieved by the choice and thickness of the resilient foams therein. Also, the resilient door panels are magnetically attracted to a gasket seal on a doorframe to provide an affirmative seal. Active magnetic control may enhance the attraction or repulsion of the door panel. Frost control is realized by warming air from the cold storage locker and passing it through air channels in the door panel proximate to the gasket seal and down an astragal interface between door panels. Door panels of laminate, bagged poured foam formation, and self-skinning foam formation further reduce the cost of manufacture and shipping.

### CROSS REFERENCE TO RELATED APPLICATIONS

The present application is a continuation-in-part application of U.S. patent application Ser. No. 10/339,822, entitled “AIR HEATED, FLEXIBLE DOOR PANEL” to Berry et al., filed Jan. 10, 2003, the disclosure of which is hereby incorporated by reference in its entirety.

The present application claims the benefit of commonly-owned U.S. Pat. Appln. Ser. No. 60/717,311 entitled “SLIDING DOOR HAVING TRAILING EDGE FLOOR WEDGE”, filed on 15 Sep. 2005.

### FIELD OF THE INVENTION

The present invention relates, in general, to top-supported doors, and more particularly to resilient doors suitable for cold storage rooms.

### BACKGROUND OF THE INVENTION

So called horizontal sliding doors include at least one door panel that is suspended by a carriage that travels along an overhead track. The door panel may be manually or automatically moved from a blocking position to an unblocking position along the overhead track. Wider door openings are often spanned by having two bi-parting door panels. In some instances, the amount of overhead track required to extend beyond the door opening is reduced by having the door panel vertically divided into a number of coupled (e.g., over-lapped, hinged) vertically-separated leaves that take up less horizontal space when moved to the unblocking position.

Cold storage lockers are often accessed through a door opening closed by a sliding door. The panels for this purpose are typically transparent vinyl sheets, minimally insulated flexible panels or foam filled rigid panels. The transparent vinyl sheets are selected to reduce the likelihood of damage to the door. In particular, such doors are used in institutional (e.g., warehouse) settings wherein palletized cargo is moved in and out of a cold storage locker by a forklift. Another advantage to these doors is that forklift operators can see what is on the other side of the door before opening the door. Although providing damage resistance, these types of panels have a very low insulation value and are too flexible to provide an effective air seal between the environments on either side of the opening. Because of the properties of the material, the transparent vinyl sheets may develop a warp that prevents a good seal. Air pressure differentials will cause leakage due to the lack of a compressive seal between the door panels and the doorframe. This will allow a significant amount of warm moist air to enter the cold storage locker and/or refrigerated air to be lost into an unrefrigerated space. Consequently, such door systems are less efficient to operate and can suffer from ice accumulation in the cold storage locker.

Rigid door panels are often used, especially in the United States, in order to reduce the operating costs of a cold storage locker. The rigid panel provides a consistent surface to seal to the doorframe. The thickness of the rigid door panel is selected to provide a specific amount of insulation. While these rigid door panels provide an effective closure, impact by a forklift can cause damage to the door system that would make them inoperative and limit access to the cold storage locker.

Attempts have been made to provide a damage resistant door panel for a sliding door system that also provides sufficient insulation. Resilient door panels have been suggested which have sufficient thickness to insulate like a rigid door panel, but yield to a degree when impacted by a forklift. While the panel itself achieves a degree of insulation, the insulation capability of the overall door system suffers from poor sealing between panels and poor sealing between a panel and the doorframe. Specifically, the stiffness of each door panel tends to be less than that of a rigid door panel, and thus presents less of a compressive contact to a doorframe gasket to achieve a seal. To achieve a seal with this type of panel, different devices have been tried. Interlocking gaskets can be damaged as the door is pulled away from the casing. In addition they require rigid plates in the door panel for attachment which makes the panel heavier and less resilient. Others have used wall mounted guide tracks to pull the middle of the door back. This adds additional cost, makes installation more difficult and does not address sealing of the entire edge of the door; it only forces a seal at the top, bottom and middle. Because of the application, it is difficult to add electrical wiring to the panel because it is flexible and could be torn open and damage or expose wiring. Condensation control on the panel is typically done using resistance wire but that does not work because of the panel design. Others have tried using external heaters and blowers that are an inefficient means of controlling the condensation.

Consequently, a significant need exists for an improved door system that is suitable for institutional cold storage lockers, which can be accomplished by providing significant thermal insulation and efficient condensation control, yet remain resistant to damage from impacts.

### BRIEF SUMMARY OF THE INVENTION

The invention overcomes the above-noted and other deficiencies of the prior art by providing a resilient door panel for a sliding door system that achieves a good seal to a doorframe by attracting the door panel. The compressive seal is achieved without reliance upon a rigid back surface of the door panel, or upon the weight of the door panel. Therefore, materials and assembly methods may be selected for a desired resilience, insulation and economy of manufacture. Yet, upon inadvertent impact, the flexible door panel swings, minimizing damage.

In one aspect of the invention, a resilient door panel is used in a closure system. A seal is formed by urging together a flexible door panel against a door frame. When inadvertent contact occurs to the flexible door panel, the flexible door panel readily releases from the door panel, bending to absorb the impact with minimal damage. Advantageously, flexibility is achieved with an inner mosaic of rigid foam pads that are sandwiched within front and back layers.

In another aspect of the invention, after deflecting to avoid damage, the closure system may reset by fully opening and closing the flexible door panel to bring a leading edge back within close proximity to be urged again into sealing contact. Thus, after an impact, the resilient door panel moves away from the wall to avoid damage, and automatic resetting advantageously restores the insulating seal across the doorway.

In yet another aspect of the invention, the urging of the door panel against the door frame is provided by a wedge guide attached to the floor that advantageously allows a door panel to translate without contact with a wall. Thereafter, an outwardly projecting cam surface attached to a trailing edge of the door panel contacts the wedge to cause sealing as the door panel approaches full closure. Thereby, a resilient or a rigid door is advantageously held in sealing contact yet a reduced profile retention mechanism is used that intrudes less into a warm room space allowing greater use of the space.

These and other objects and advantages of the present invention shall be made apparent from the accompanying drawings and the description thereof.

### DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a front exploded perspective view of a damage resistant door system for an institutional cold storage locker.

FIG. 2 is a diagrammatic view of a frost resistant sealing system of the door system of FIG. 1.

FIG. 3 is a top diagrammatic view of an astragal between the two door panels of the door system of FIGS. 1-2.

FIG. 4 is a front view of a doorframe-mounted portion of a frost control system of the door system of FIG. 1.

FIG. 5 is side cross sectional view along line 5-5 of FIG. 1 exposing an air passage of the frost control system passing through both the doorframe-mounted portion and a door panel.

FIG. 6 is a cross sectional, detail view taken along line 6-6 of the air channel and gasket seal of the door system of FIG. 1.

FIG. 7 is an exploded perspective view of a resilient, laminated door pad with a cover removed for the door system of FIG. 1.

FIG. 8 is an exploded perspective view of the door panel of FIG. 1 including the resilient laminated door pad of FIG. 7.

FIG. 8A is a perspective view of an alternative resilient door panel for the damage-resistant door system of FIG. 1.

FIG. 8B is a perspective exploded view of the alternative resilient door panel of FIG. 8A with the hanging structure removed and an outer flexible layer removed from an inner laminate flexible core.

FIG. 8C is a perspective exploded view of the inner laminate flexible core of FIG. 8B comprising a center vertical mosaic layer of rigid foam blocks sandwiched between front and back resilient layers.

FIG. 9 is a cross sectional view along line 9-9 of a magnet embedded portion of the door panel of FIG. 8.

FIG. 10 is a cross sectional view along line 10-10 of a bottom edge air passage of a sill of the door panel of FIG. 8.

FIG. 11 is an exploded view of the door mounted gasket assembly of the door system of FIG. 1.

FIG. 12 is a horizontal cross sectional view along line 12-12 of FIG. 1 illustrating a passive gasket system of the door system.

FIG. 12A is a horizontal cross sectional view along line 12-12 of FIG. 1 illustrating an alternative, active gasket system of the door system.

FIG. 12B is a horizontal cross sectional view along line 12-12 of FIG. 1 illustrating an alternative, loop gasket system of the door system.

FIG. 13 is a diagrammatic view of an alternative frost control system including recycled warmed air for the door system of FIG. 1.

FIG. 14 is a diagrammatic view of an alternative air-stiffened door panel for the door system of FIG. 1.

FIG. 15 is a horizontal cross sectional view of the door panel of FIG. 14.

FIG. 16 is a further alternative air stiffened door panel for the door system of FIG. 1.

FIG. 17 is a perspective, partially cutaway view of an alternative bagged, poured foam door panel for the door system of FIG. 1.

FIG. 18 is a horizontal cross sectional view of the bagged, poured foam door panel of FIG. 17.

FIG. 19 is front diagrammatic view of the door panel of FIG. 17 being filled with poured foam.

FIG. 20 is a perspective, partially cutaway view of a further alternative fixture for forming an unbagged, poured foam door panel for the door system of FIG. 1.

FIG. 21 is a front cross sectional view along line 21-21 of the fixture and foam attachment device of FIG. 19.

FIG. 22 is a perspective view of a completed self-skinning door panel formed in the fixture of FIG. 19.

FIGS. 23A-F are top view diagrams of a damage-resistant door system incorporating an auto-reset feature.

### DETAILED DESCRIPTION OF THE INVENTION

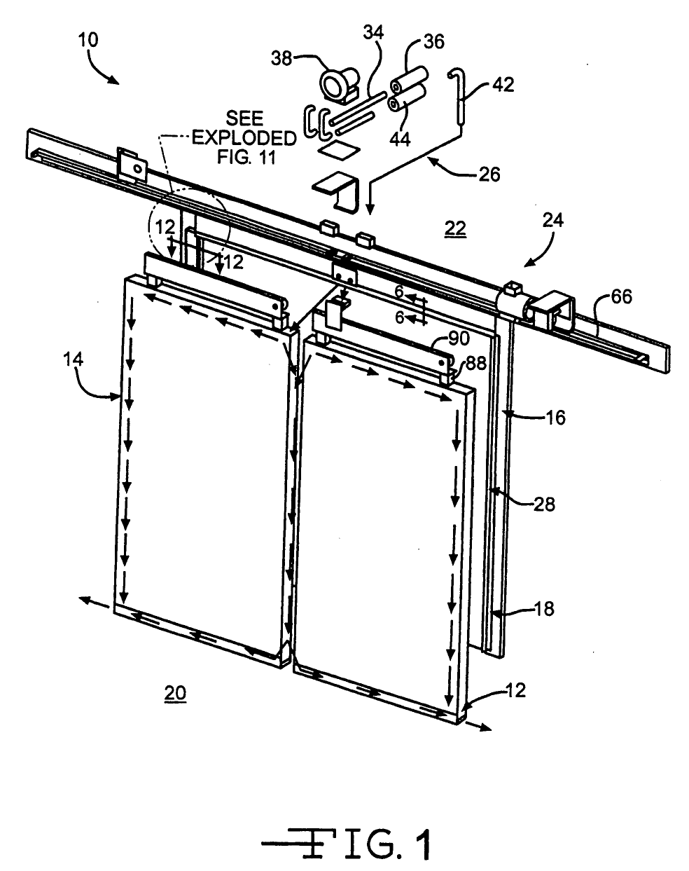

Turning to the Drawings wherein like numbers denote like components throughout the several views, in FIGS. 1-3, a closure system, depicted as a bi-parting horizontal sliding door system 10, advantageously includes fully resilient door panels 12, 14 for damage resistance that are affirmatively sealed to a doorframe 16 by an attraction sealing system, depicted as a magnetic sealing system 18, to effectively separate a warm space 20 from a cold space 22 (e.g., a cold storage locker). As shown particularly in FIG. 1, the door panels 12, 14 are supported by and power actuated by an overhead carriage 24, as is generally understood by those skilled in the art.

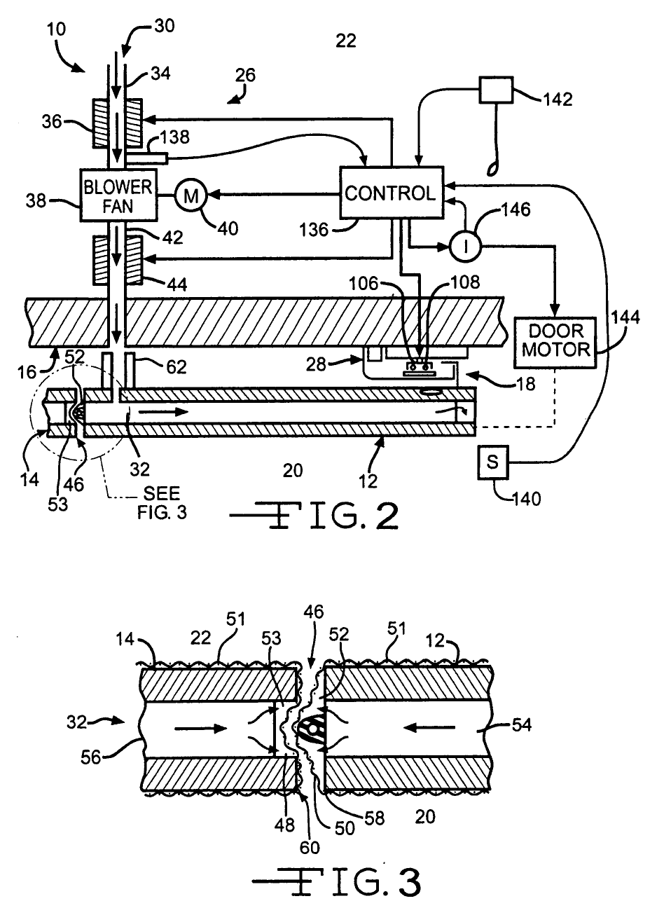

With particular reference to FIG. 2, the sliding door system 10 advantageously includes a frost control system 26 for preventing accumulation of ice on a sealing gasket 28 on the doorframe 16. Cold air from the cold space 22 passes through and is warmed by an air passage 30 that includes an air channel 32 in a periphery of each door panel 12, 14. In particular, the cold air is drawn through an intake manifold 34, which is encompassed and warmed by an upstream electric heater 36, into an air mover, depicted as a blower fan 38 driven by an electric motor 40. The upstream heater 36 provides dry, warm air to the blower fan 38, allowing the blower fan 38 to operate in an environment that promotes its reliability. Pressurized air from the blower fan 38 is then directed through an exhaust manifold 42, which is advantageously encompassed by a downstream electric heater 44 that further warms the air to a temperature sufficient to keep the sealing gasket 28 frost free, although it will be appreciated that one heater may be sufficient in some applications or that the heating is performed in the air mover.

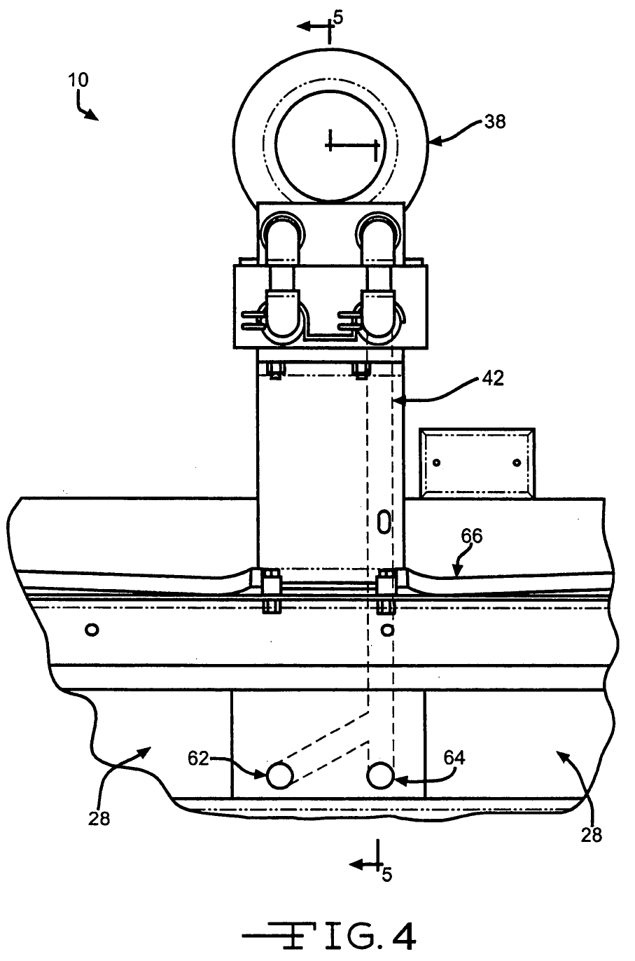

With particular reference to FIG. 3, an astragal contact 46 between the right door panel 12 and the left door panel 14 is depicted. In the nearly closed position as depicted, a concave, vertical recess 48 of the left door panel 14 receives a vertical rounded end 50 of the right door panel 12. The recess 48 and rounded end 50 define a vertical astragal air channel 52 that is in communication with a horizontal air channel 54 of the right door panel 12 and with a horizontal air channel 56 of the left door panel 14. Thereby, leading edges 58, 60 respectively of panels 12, 14 contact each other for a good sealing between the warm and cold spaces 20, 22 while also directing warmed air downward throughout the astragal contact 46 to prevent frost accumulation.

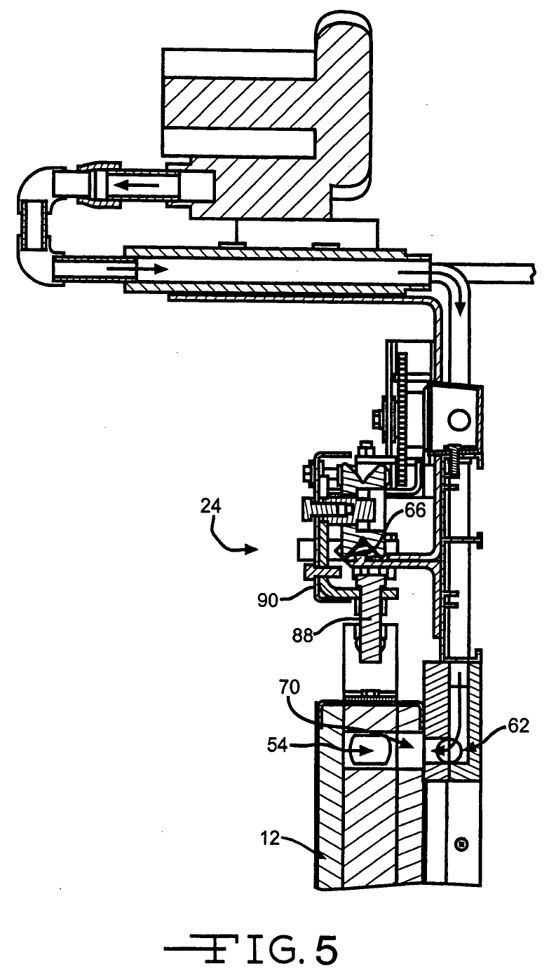

With particular reference to FIG. 4, the exhaust manifold 42 is shown separating into right and left outlet ports 62, 64 for directing warmed air to a respective door panel 12, 14 (not shown in FIG. 3). Also depicted is a down-and-in track 66 of the overhead carriage 24 that presents the door panels 12, 14 into compressive contact with the outlet ports 62, 64 and a horizontal gasket assembly 68 of the sealing gasket 28, yet avoid frictional wear as the door panels 12, 14 are positioned.

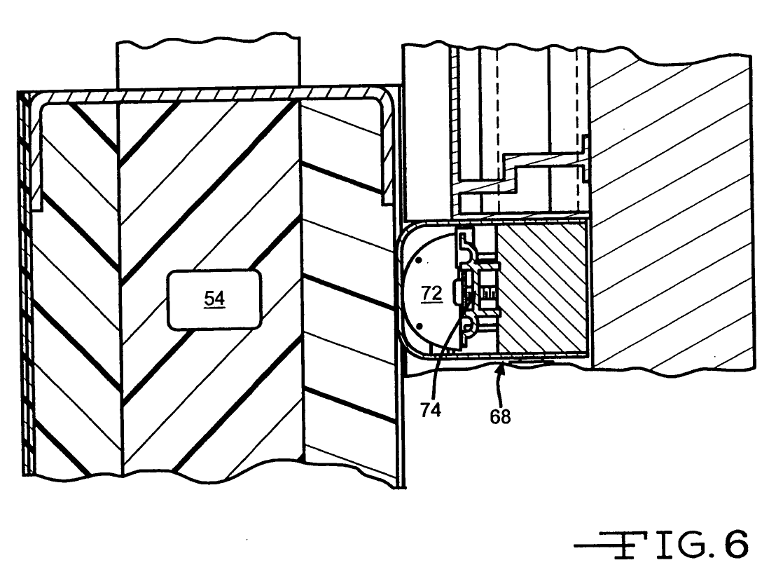

In FIG. 5, the right outlet port 62 is depicted as positioned to communicate with the horizontal air channel 54 in the right door panel 12 via back face air passage 70. Also depicted in more detail is the overhead carriage 24.

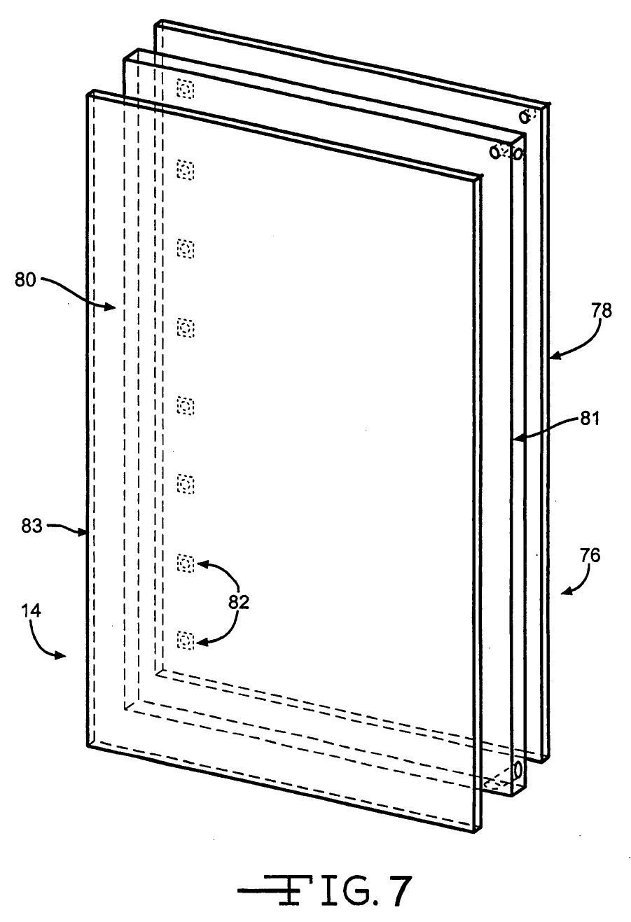

In FIG. 6, the horizontal air channel 54 in the door panel 12 is shown proximate to the horizontal gasket assembly 68. In this illustrative version, the door panel 12 is compressed into the horizontal gasket assembly 68 without having to use magnetic attraction. Thus, the horizontal gasket assembly includes a resilient plug 72 between its over surface and a heated support structure 74.

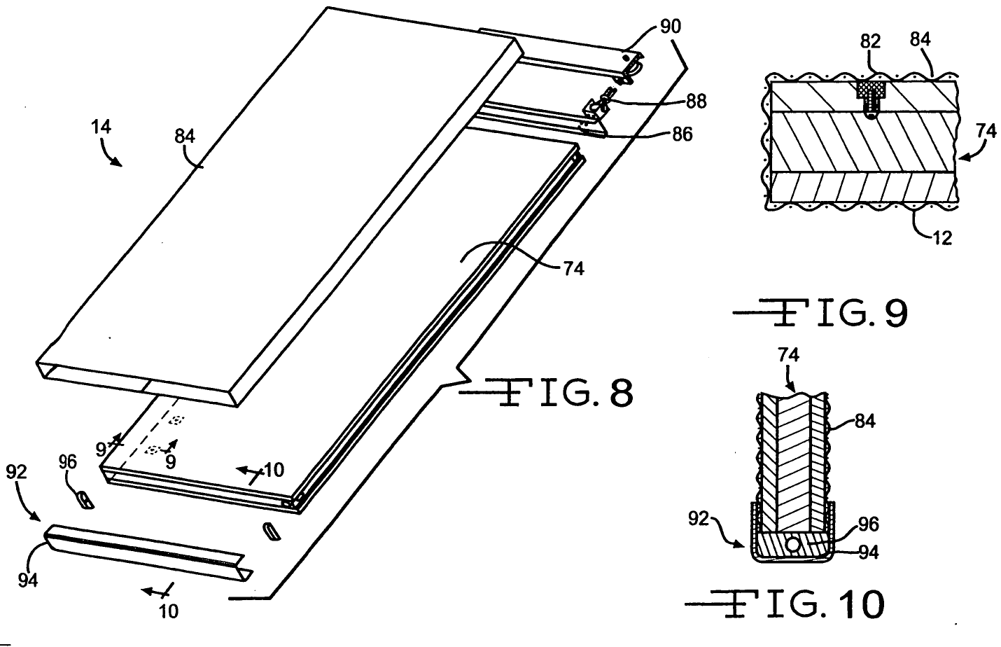

In FIG. 7, the resilient portions of the door panel 14 are shown. In particular, a composite pad 76 is formed from two flexible neoprene sheets 78, 80, selected for a high degree of resilience for impacts, which are glued respectively to each side of a more rigid polyethylene slab 82, selected for holding the shape of the pad 76 and for receiving a drilled horizontal air channel 54 and routered vertical air channel (both not shown in FIG. 7) about its trailing edge 84. Permanent magnets 82 are embedded in the back neoprene sheet 78.

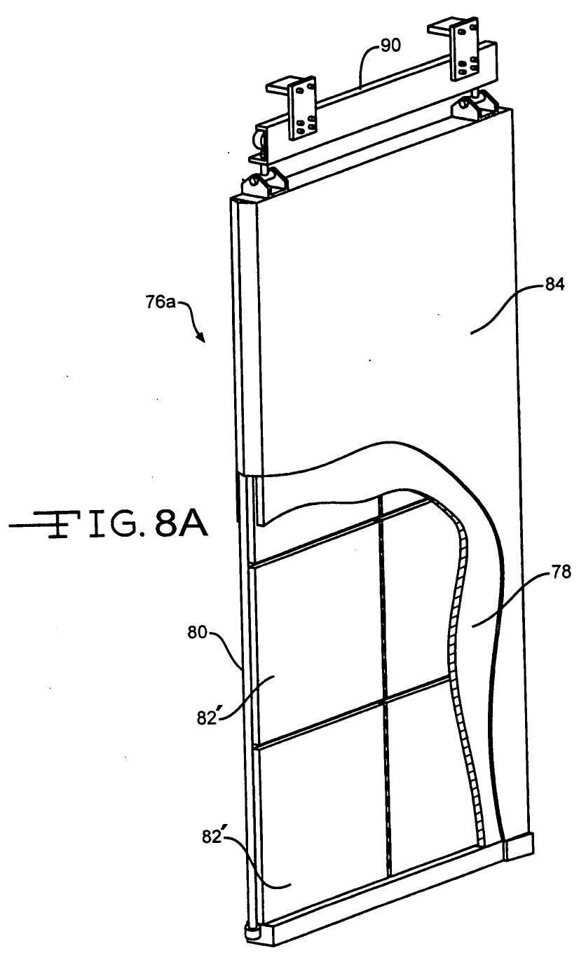

In FIGS. 8A-8C, an alternative composite pad 76a may be formed from a rigid material such as polyurethane insulation, typically used in rigid door panels, in place of the polyethylene slab 82. Flexibility is achieved by dividing the urethane insulation into a plurality of rectangular pieces 82′ arranged in a tile pattern. The pieces are held in place by being bonded directly to the protective layers of neoprene sheets 78, 80. Other protective materials may be used alternatively or in addition to neoprene to provide protection for the rigid insulation of rectangular pieces 82. The size of the pieces 82′ may advantageously be chosen for the desired degree of flexibility. For example, the tile size may be reduced at lower portions more prone to impact. Moreover, for a given thickness, the urethane has a higher insulation value than polyethylene. Thus, if more flexibility is desired, the thickness of the panel may be reduced without sacrificing insulation by using more effective insulation such as urethane in place of polyethylene. Alternatively, the same thickness of the panel may be maintained with a realized increase in economic efficiency. With particular reference to FIG. 8B, it should be appreciated that an outer cover 84 of polyvinyl chloride (PVC) fabric or urethane fabric encompasses the composite pad 78, 80, 82′ and may consist of a plurality of pieces of fabric.

It will be appreciated that a number of materials may be used depending upon the degree of insulation, flexibility, thickness, cost, chemical environment, etc. Additional examples include a silicone sheet, a bead board, cross linked polyethylene, etc.

In FIGS. 6 and 8, the assembled pad 74 is shown with the cover 84 of polyvinyl chloride (PVC) fabric that is glued over the pad 74. The assembly is attached with adhesive and mechanical fasteners to a structural member 86 across the top of the pad 74. Attachment members 88 spaced along the top of the structural member 86 are fastened to a roller assembly 90, which rides on the track 66 of the overhead carriage 24 (shown in FIG. 4). Some applications consistent with the present invention may not require the structural member 86 due to the inherent weight of the top of the pad 74.

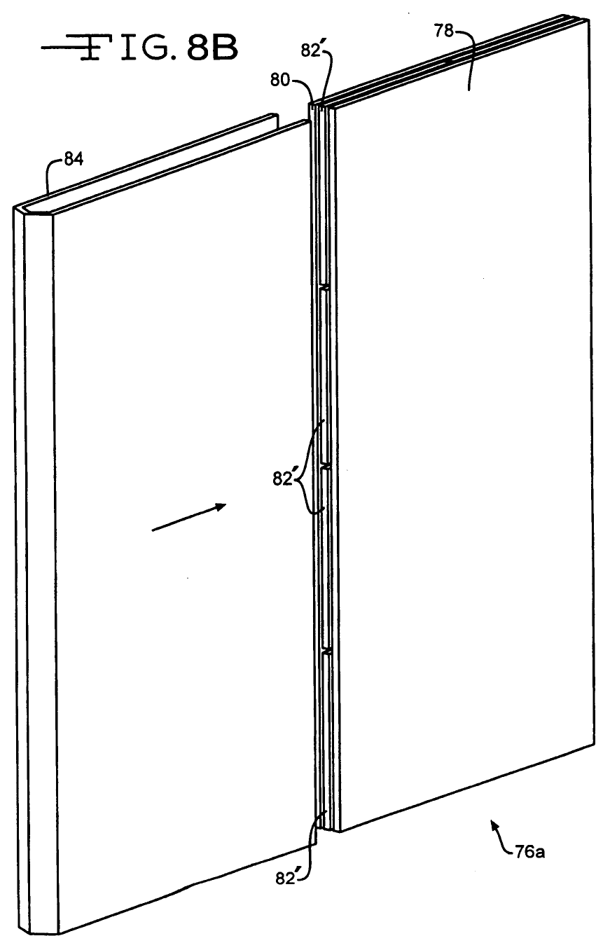

In FIG. 9, one permanent magnet 82 is shown embedded in an assembled panel 12. Such magnets 82 may be incorporated as well into the alternative composite pad 76a of FIGS. 8A-8C.

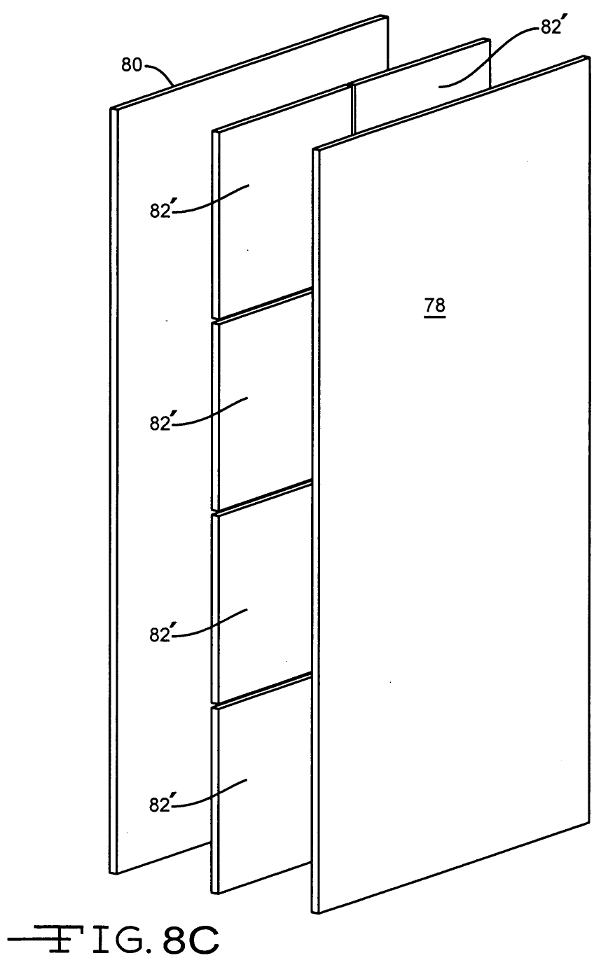

In FIGS. 8 and 10, a bottom sill 92 is shown wherein a bottom structural member 94 is affixed to the bottom of the pad 74. Perforated supports 96 space the pad 74 above the bottom structural member 94 and define the bottom portion of the air channel 32 in the door panel 12.

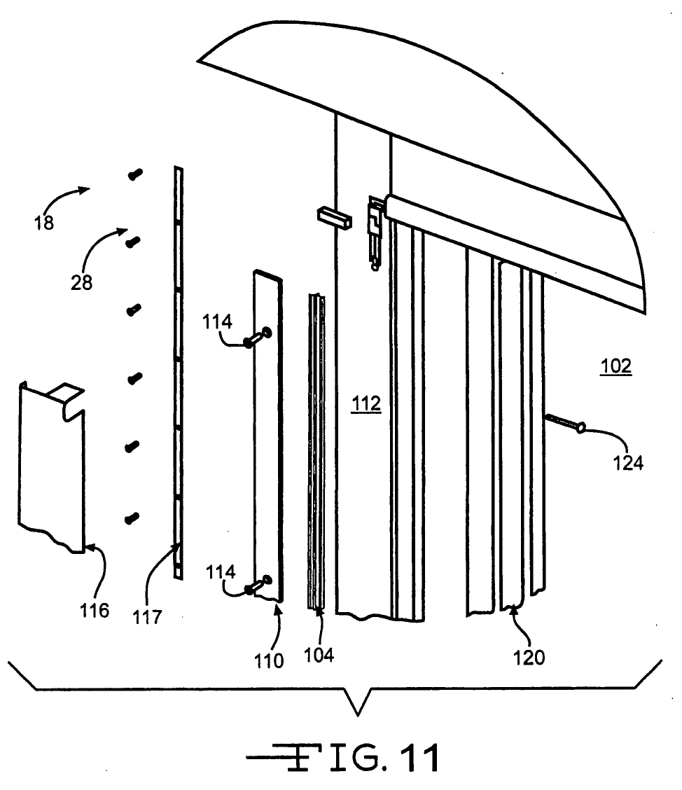

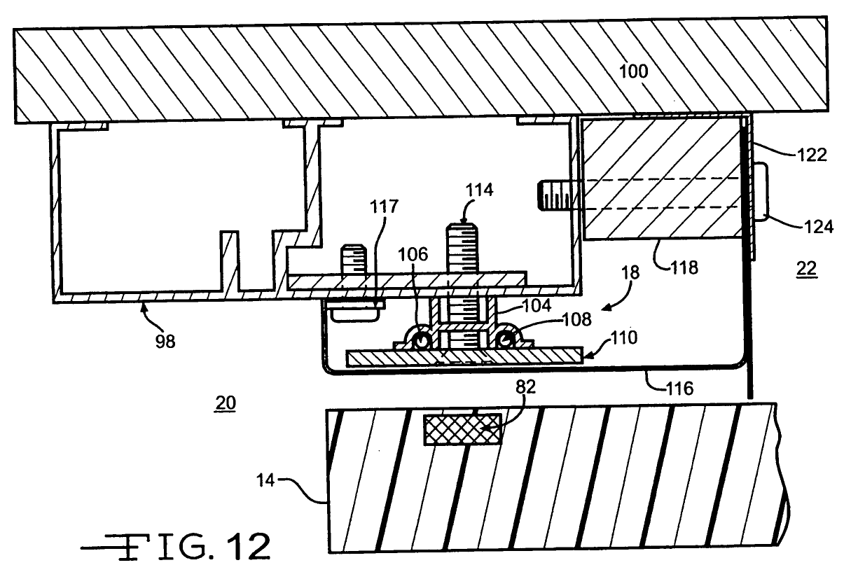

In FIGS. 11-12, the magnetic sealing system 18 of the gasket seal 28 is shown in greater detail. A frame casing 98 is mounted to a front face of a wall 100 that defines a door opening 102. For instance, the casing 98 may comprise metal sheeting encasing a wood beam as is generally known. The wood may be replaced with another core material such as urethane to avoid problems associated with use of wood in a moist environment (e.g., swelling, bacteria growth, rotting). If plastics are used, the covering material may be adhered to the core material to minimize thermal distortion. This can be done by injecting the core material into a preformed cover or wrapping a cover of a preformed core and bonding it to the core. Advantageously, the casing 98 may comprise formed or extruded material (metal, plastic, fiber reinforced composites) as strength, stiffness or temperature conditions dictate.

An aluminum extruded guide 104 cradles two resistive electrical cables 106, 108 and is held in place between a ferrous strip 110 and a front surface 112 of the casing 98 by fasteners 114. A primary gasket 116 of PVC or other flexible reinforced fabric is bolted through a strip 117 to the front surface 112 and is wrapped over the ferrous strip 110 and a spacer block 118, over which a secondary gasket 120 is placed and held in place by an angled bracket 122. The secondary gasket 120 may alternatively be positioned outboard of the primary basket 116 as well as inboard at the door opening as depicted. Fasteners 124 pass through the bracket 122, secondary gasket 120, primary gasket 116, and spacer block 118 to attach to an inner surface 126 of the casing 98. When the door panel 12 draws near its closed, blocking position, the magnets 82 draw the door panel 12 toward the ferrous strip 110.

FIG. 12A depicts an active magnetic attraction system 128 that provides additional control features over the previously described passive magnetic attraction system 18. A gasket seal 130, that incorporates the active magnetic attraction system 128, is similar to that described for FIG. 12 with an electromagnet 134 mounted to a ferrous or non-ferrous strip 110. In the case of a non-ferrous strip, the door pad 12 tends to stay in place under the magnetic attraction between the permanent magnet 82 and the electromagnet 134. When opening the door panel 12, the electromagnet 134 may be advantageously polarized to the same magnetic pole as the adjacent face of the permanent magnet 82, thereby repulsing the door panel 12. The repulsion assists in overcoming any frost present and tends to hold the panel 12 away during movement to avoid frictional damage. The electromagnet 134 may assist in pulling the door close enough to the ferrous strip 110 that the permanent magnets 82 in the door will thereafter hold the door in place without the help of the electromagnet. When the door opens, the pole on the electromagnet 134 can be reversed to break the seal and make it easier for the door to open.

It will be appreciated that the door panel 12 may include a ferrous target (not shown) rather than a permanent magnet wherein the electromagnet 134 actively holds the door panel 12 closed and is deactivated when opening the door panel 12.

FIG. 12B depicts a low-wear gasket system 18a, similar to the magnetic sealing system 18 of FIG. 12 except that the main gasket is no longer under pressure from a magnet assembly thereby eliminating a source of friction and wear to the door panel 14. Instead, the magnetic attraction feature has been provided separately as a rearwardly projecting, trailing edge magnetic flap 131 that acts as its own primary seal. A loop 133 of PVC fabric is attached along the full height of the trailing edge of the door panel 14 and is directed inwardly toward the wall 100. A small permanent magnet 82a, affixed to the inside of the loop 133, is registered to be attracted to a ferrous plate 135 attached to a vertical, outward edge of the frame casing 98. In addition to eliminating the frictional wear from the secondary gasket 120, this trailing edge magnetic flap 133 may accommodate a door panel 14 with additional flexibility and curve. Moreover, the permanent magnet 82a is advantageously small in that its amount of magnetic field strength need only be great enough to draw a rather light weight flap 133 into contact with the ferrous plate 135 rather than to draw the entire door panel 14 into contact.

Returning to FIG. 2, the operation of the door system 10 generally begins with the door panels 12, 14 closed as depicted, with permanent magnets 82 drawing the door panel 12 into contact with the gasket seal 28. A door controller 136 energizes resistive electrical cables 106, 108 in the gasket seal 28 to assist in frost control. The door controller 136 also energizes the motor 40 to turn the blower fan 38 to draw cold, dry air from the cold space 22 into the air passage 30. Specifically, in the intake manifold 34, the cold air is partially warmed by the upstream electrical heater 36 to keep the blower fan 38 and motor 40 in an optimum temperature range. Also, the pressurized air is further warmed by the downstream electric heater 44. The door controller 136 may closed-loop control the temperature of the warmed air with a temperature sensor 138, such as depicted in the intake manifold 34. It will be appreciated that one or more sensor may be used to optimize the temperature in various regions of the air passage 30. The warmed air is passed through the outlet port 62 into the air channel 32 in the door panel 12. The warmed air passes through the astragal passage air channel 52 with the panel 14 and around the periphery of the door panel 12 proximate to the gasket seal 28 and thereafter is vented into the warm space 20. The door controller 136 may condition activation of the frost control system 26 on confirming that the door panel 12 is closed, as sensed by a switch 140.

In response to user actuation of an opening device, depicted as a door pull rope switch 142, the door controller 136 deactivates the frost control system 26 and may activate the electromagnet 134 (if present) (not shown in FIG. 2) to repulse the door panel 12. The door controller 136 then actuates a door motor 144, such as a two-speed, three phase electric brake motor, that is coupled to the door panel 12. It will be appreciated that a single speed motor with a variable frequency drive may be used as another alternative. Once opened, the door controller 136 awaits until user actuation of the door pull rope switch 142 to close the door panel 12. The door controller 136 may monitor a sensed pneumatic pressure on one or both leading edges 58 to reverse or stop the door motor 144 as a safety feature. The door controller 136 may also monitor stalling of the door motor 144 indicative of system failure or other blockage, such as by monitoring motor current “I” with a current sensor 146. It will be appreciated that, due to the flexible nature of the door panel 12, monitoring of motor current may be sufficient without a pneumatic sensor on the leading edge.

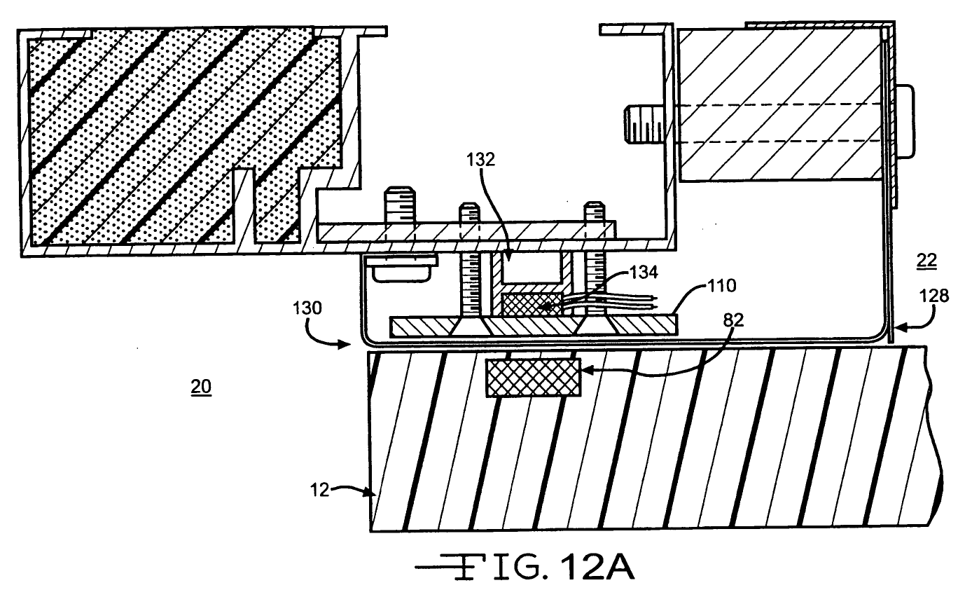

In FIG. 13, an alternative door system 148 illustrates additional features that may be incorporated into a pressurized frost control system 150. Recycling the pressurized air rather than venting the air into the warm space 20 may advantageously reduce the amount of electrical power required to keep the door panel 12 warm. Another advantage or use would be to air stiffen the door panel 12 by inflating air tubes 152 in the door panel 12.

Air recycling is shown with a return passage 154 from the door panel 12 to an upstream intake 156 of the blower fan 38. A check valve 158 may be included in the intake manifold 34 to prevent inadvertent porting of return air into the cold space 22. In addition, a pressure relief check valve 160 may advantageously be included in the return passage 154 to prevent damage to the door panel 12 such as during an impact.

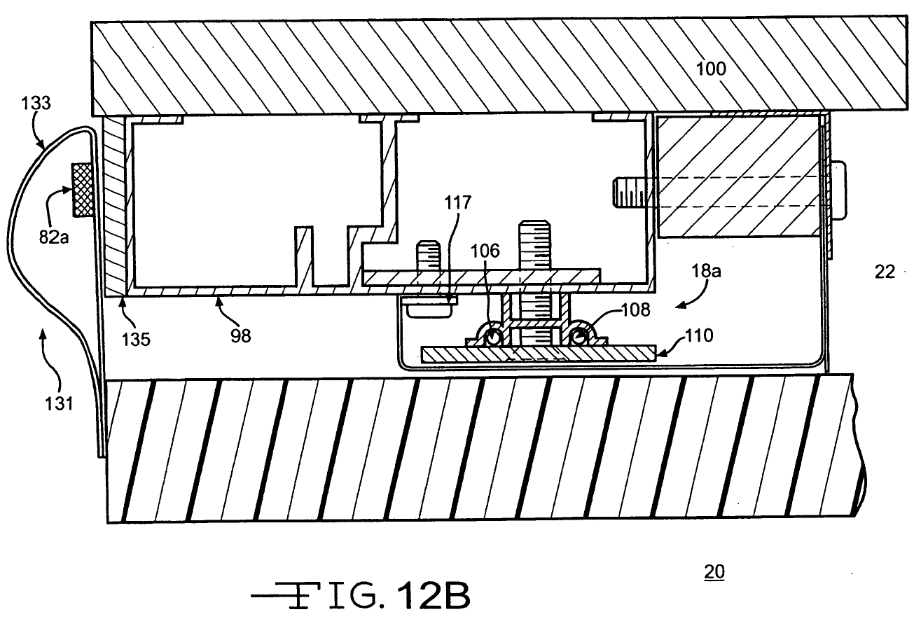

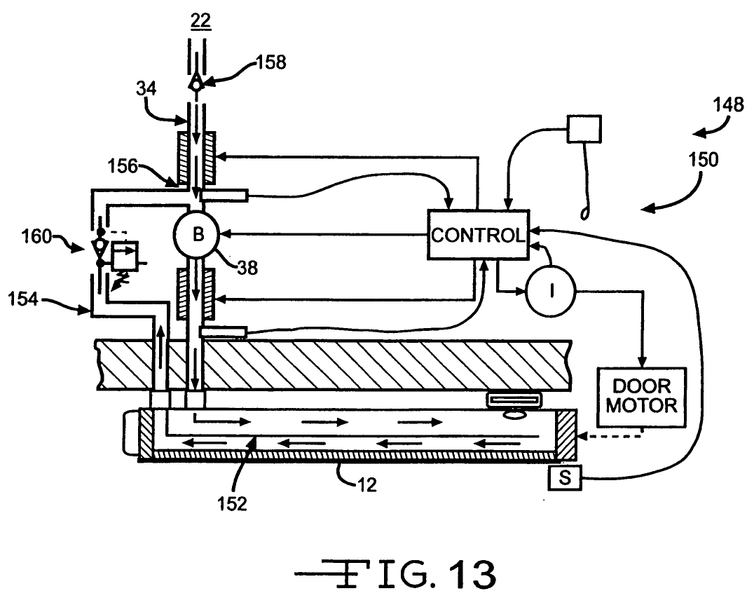

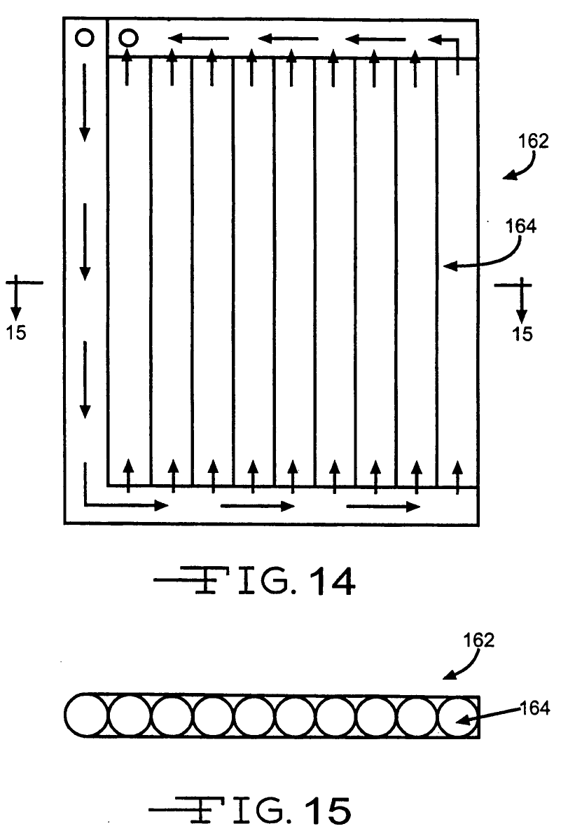

In FIGS. 14-15, an air-stiffened door panel 162 is depicted wherein the warmest air is first directed around the periphery for gasket warming purposes and also allowed to pressurize vertical air tubes 164. In FIG. 16, an alternative air-stiffen door panel 166 includes a porous or quilted central portion 168 that is pressurized.

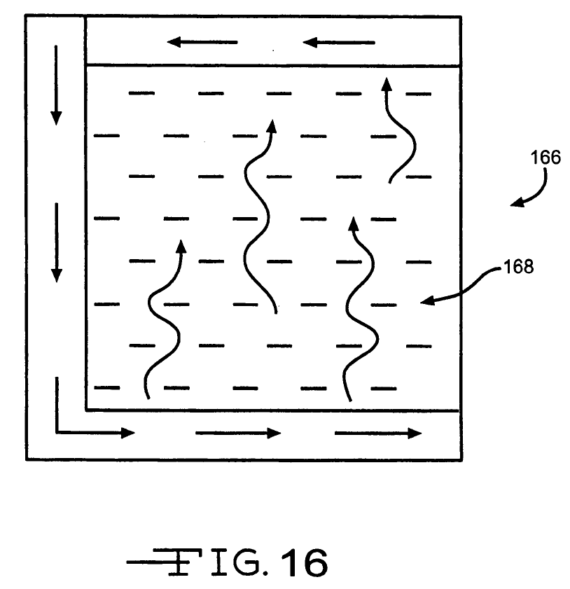

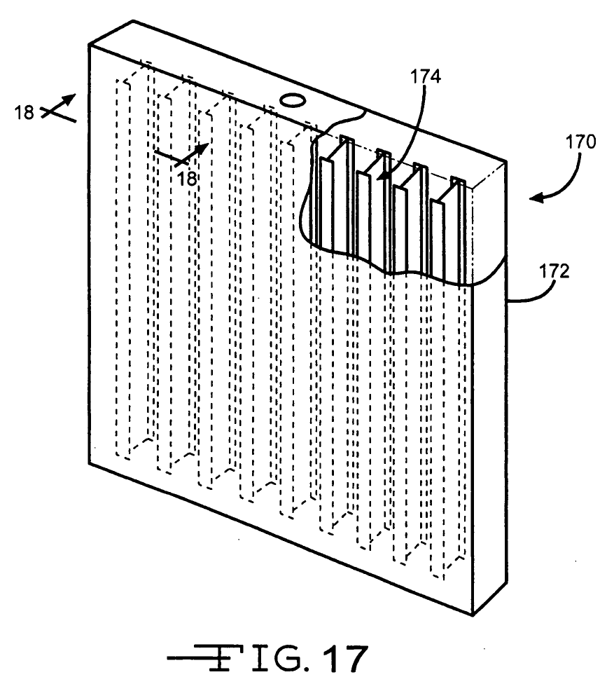

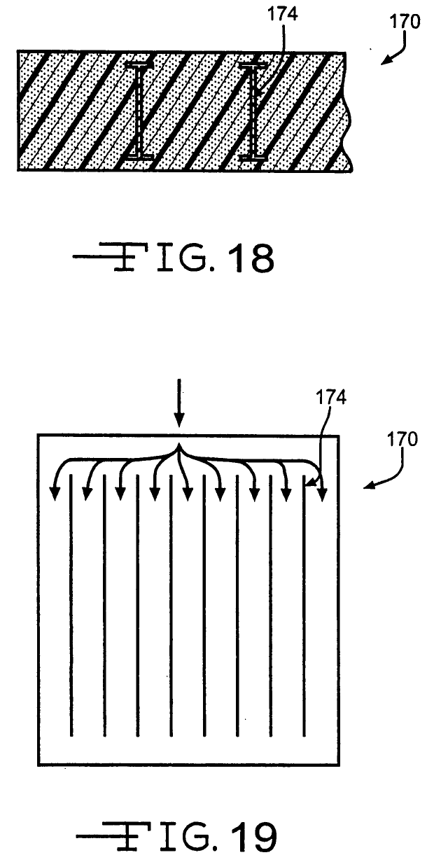

In FIGS. 17-19, a bagged, poured foam door panel 170 is depicted as an alternative to glued foam laminate construction. A bag cover 172 includes a plurality of vertical dividers constructed of a material similar to the bag 174 that control the flow of uncured foam so that the resulting door panel 170 has the desired shape. Thereby, use of a large fixture may not required. Moreover, large shipping containers may be avoided by shipping an unfilled bag cover 172 with a supply of uncured foam (not shown) that is used on location. Features such as permanent magnets (not shown) may be affixed to the bag cover 172.

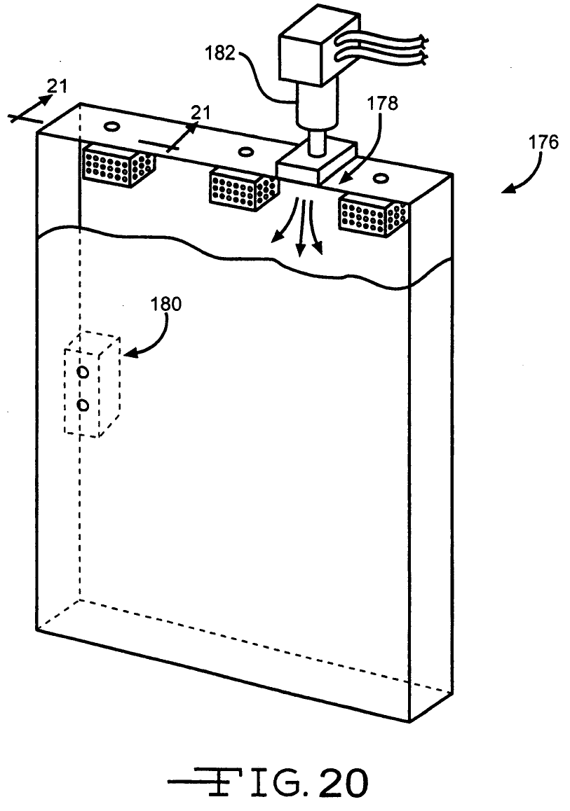

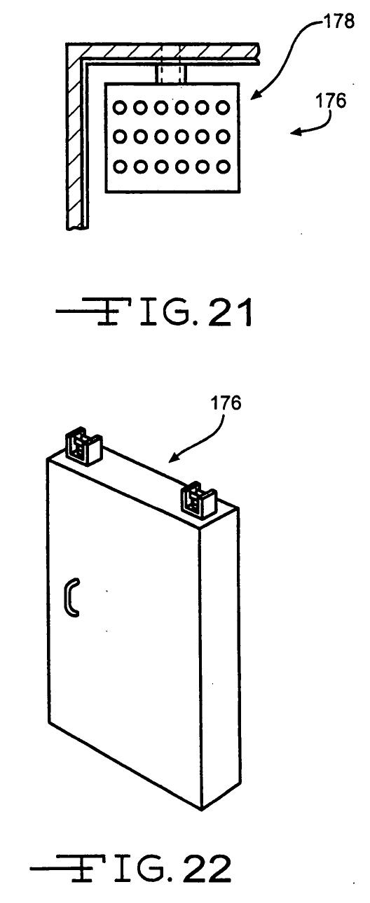

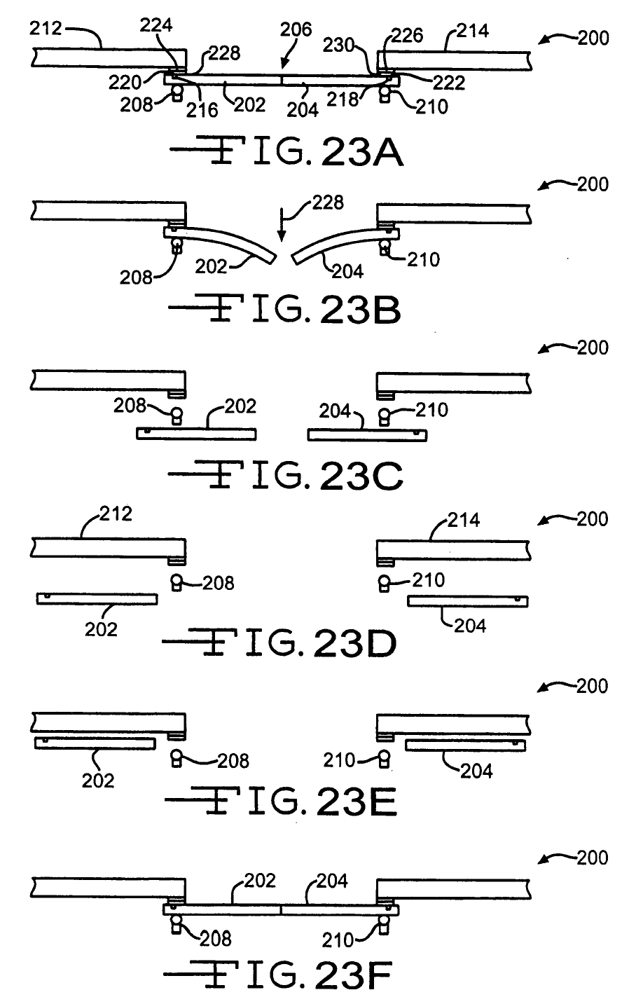

In FIGS. 20-22, an unbagged, poured foam door panel 176 may have advantages in reducing the cost of manufacturer by eliminating the bag cover. A fixture (not shown) positions hanger structures 178 and other door hardware 180 until injected foam 182 cures onto these elements. The hanger structures 178 may be of various forms that facilitate a large surface area attachment to the foam with horizontal protrusions to resist pull-out, for instance, a “tree root” like structure, perforated plate, or simple bar with cross pieces, etc. A self-skinning flexible foam advantageously attaches to the hanger structures 178 and forms a wear resistant surface without the additional manufacturing step of attaching a cover.

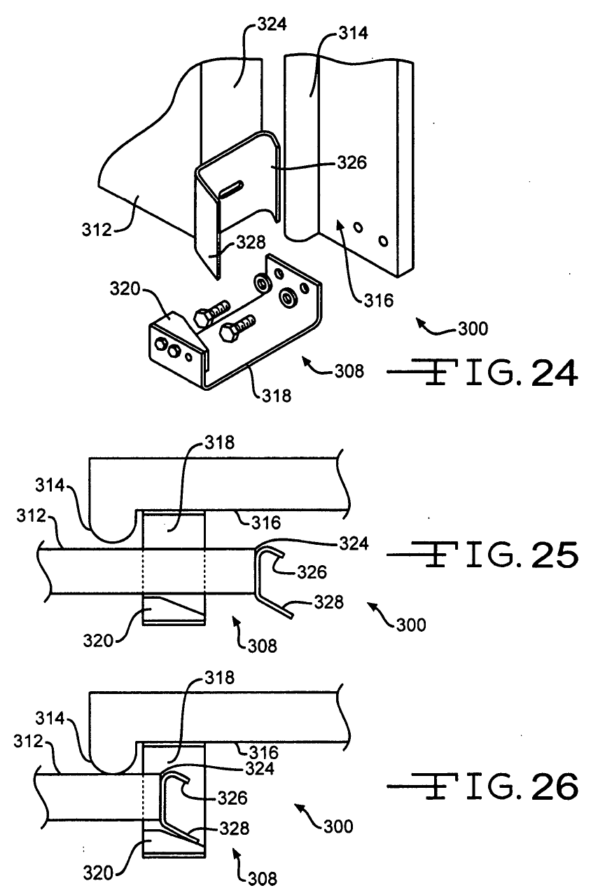

FIGS. 23A-F depict operation of an auto-reset feature of a damage-resistant door system 200 that may advantageously be incorporated into applications that are automatically actuated. In FIG. 23A, the door system 200 is depicted in its normal, closed position with left pad 202 abutting right pad 204, thereby closing a door opening 206. The distal lower portions of the left and right pads 202, 204 are each inwardly held by left and right restraining devices 208, 210 against left and right doorframes 212, 214, respectively, forming a seal against corresponding left and right gaskets 216, 218.

In the illustrative embodiment, the restraining devices 208, 210 are rollers but could be any device protruding upwards on the front side of the panels 202, 204. These restraining devices 208, 210 may be attached to the floor or to the door casing. In the latter configuration, the restraining device may require that a bracket go under the door to hold the restraining device. It should be appreciated that the left and right restraining devices 208, 210 may have application in manually opened door systems as well as automatically opened door systems, especially when significant air pressure differential exists at times across the door opening or when the door pads 202, 204 are sufficiently flexible and need an urging at their lower portions to seal against the doorframe 212, 214. In some applications, the normal travel of the door panels 202, 204 may maintain the respective restraining device 208, 210 in contact, avoiding any damage when the leading edge of the door panels 202, 204 encounters the restraining device 208, 210 when closing. In other applications, the door panels 202, 204 at their most open position are not in contact with the restraining devices 208, 210. Thus, guides (not shown) may inwardly direct the leading edge of the door panels 202, 204 to counter any outward deflection of the lower portion of the door panel 202, 204.

Although the restraining devices 208, 210 advantageously assist in sealing the flexible door panels 202, 204, mitigating damage from impacts is enhanced by having the restraining devices 208, 210 sufficiently low as to allow an outwardly forced door panel to pop over the restraining device 208, 210. Sufficient lateral travel in the overhead carriage (not shown in FIG. 23A) thus allows the door to be reinserted between the restraining devices 208, 210 and doorframe 212, 214 when cycled fully open and then closed.

In some applications, it is advantageous to retain a normal operation wherein the door remains at all times in contact with the restraining device 208, 210, avoiding impact to the leading edge, while also providing for the resetting after the door panel 202, 204 is forced outward during an impact. Moreover, it is a further advantage for the door to begin to open when a forklift impacts the door panel 202, 204 to thereby minimize the amount of deflection required for the vehicle to pass through.

To that end, a capability for sensing that the door panels 202, 204 have achieved a fully closed position with an effective seal is provided by left and right sensors, depicted as left and right magnetic field transducers 220, 222 (e.g., Hall effect transducers) that sense the proximity respectively of left and right magnets 216, 218 in respective pads 202, 204. Signal lines 224, 226 to each transducer 220, 222 respectively communicate to a control system (not shown) that respond to the sensed position. It will be appreciated that sensing the magnets 216, 218 takes advantage of magnets that also assist in sealing the door panel 202, 204 to the doorframe 212, 214. However, other types of sensors may be used, such as mechanical limit switches, optical sensors, etc.

In FIG. 23B, an impact is illustrated at arrow 228 as coming inside the cold storage space, forcing the door pads 202, 204 outward. The selection and placement of sensors 220, 222 may advantageously detect impacts from both directions. For instance, an impact from either direction may tend to draw the lower, trailing edge of the door pad 202, 204 upward and inward, which may be detected by various proximity sensors. Alternatively, the impact from either direction may pull the lower, trailer edge of the door pad 202, 204 completely out from the doorframe 212, 214 and restraining device 208, 210, which may be detected by a limit switch. As yet a further alternative, multiple sensors on each side may be used to detect impact from either direction.

In FIG. 23C, the impact has caused each door pad 202, 204 to ride over the respective restraining device 208, 210. Also, the door system 200 has responded to the sensed impact by beginning to auto-set by opening the door pads 202, 204.

In FIG. 23D, the door pads 202, 204 have been drawn to a fully open position, wherein the leading edges are beyond the respective restraining devices 208, 210. The pads 202, 204 are thereafter maintained in this position for a period of time or until sensed as having swung back toward the doorframe 212, 214 under the influence of gravity, as depicted in FIG. 23E.

In FIG. 23E, the door system 200 has closed the pads 202, 204, completing the auto-reset back to the condition that existed prior to the impact. It will be appreciated that closing may be contingent upon a timer typically sufficient for any impacting vehicle to have left the door opening 206. Alternatively or in addition, automatic closing during auto-reset may be contingent upon sensing an unimpeded door opening, such as by an unblocked optical beam across the door opening 206.

In FIGS. 24-26, a door system 300 may advantageously achieve an effective seal between a horizontally translated door panel 312 that translates past a trailing edge 314 of a door side casing 316 by an alternative restraining device 308 formed by a shallow upwardly open U-shaped floor bracket 318 that is bolted to the door side casing 316 with an extended end 319 curved up with an inwardly attached wedge 320. An aft opened U-shaped bracket 322 on a trailing edge surface 324 of the horizontal door panel 312 is aft opened with an inwardly curled inner arm 326 and an advantageously outwardly and aft angled outer arm 328 that is registered to slide against the wedge 320 urging the door panel 312 into sealing engagement with the trailing edge 314 of the door side casing 316 as full closing travel is approached. Thereby, an effect restraining device 308 is achieved with less incursion into the room as compared to a roller.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

For example, while air warming of the entire periphery of a door panel may be advantageous, in some applications only one, two or three edges may be warmed. For instance, an upper edge and a trailing edge may rely solely on electrical warming in the doorframe as sufficient, whereas the leading edge and bottom edge are internally warmed by air.

While a magnetic attraction is depicted and described for advantageously compressively sealing the door panel to the doorframe, it will be appreciated that other approaches may be employed to attract the door panel to the doorframe. For example, pneumatic suction may be created about the doorframe that is presented to pull in the periphery of the door panel.

While air warming of the door panel has been advantageously depicted, it should be appreciated that other warming techniques may be employed that do not rely upon electrical wiring in the door panel. For example, inductive targets may be embedded or affixed to the periphery of a door panel. A radiated electromagnetic signal from the doorframe may then be used to inductively couple power into the inductive targets to cause resistive heating in the door panel.

Air stiffening of the door panel 12 may also be provided separate from a frost control system. For example, separate air tubes dedicated for use as air stiffening bladders may be pressurized and left pressurized rather than recycling the air for heating.

Synergy exists between using these aspects of the invention together in a door system for a cold storage locker; however, it will be appreciated that aspects of the present invention may be used separate and apart from the other features. For instance, separating environments may be very desirable for soundproofing or preventing airborne particulates from passing through the doorway. Another example is coolers that are maintained above freezing. Consequently, the effective sealing of the door panel by attraction may be employed without the need for a frost control system. As a further example, the configuration of how the door panels is positioned may provide sufficient affirmative urging into sealing contact with the doorframe so that an attraction capability is not required, although the elimination of frost at the sealing contact may still be desired.

It will be appreciated that aspects of the present invention have application to door systems that fold individual panels in an accordion fashion in order to require less lateral travel when opened. Furthermore, aspects of the present invention have application to door systems that are not supported from an overhead track.

In the illustrative embodiment of FIGS. 23A-F, the door system 200 includes both restraining devices 208, 210 and door position sensors 220, 222 that may be used in an auto-resetting feature. Although a door closed and sealed sensing capability is disclosed in combination with a physical restraining capability, it will be appreciated that door-positioning sensing has applications without the physical restraining capability. For instance, a failure indication may be given to operators when a situation is detected where the door should have achieved full travel, yet a seal is not achieved. Furthermore, automatic opening of the door upon impact may advantageously reduce damage to the door system even if restraining devices are not present.

As yet another example, a retention mechanism that urges a trailing edge of a door panel into insulating, sealing contact with a doorframe may advantageously yield upon impact to allow the door panel to swing outward to avoid damage. Such a break-away or resilient feature incorporated into a floor mounted roller or wedge guide may further be used with a rigid door to mitigate the amount of impact damage.

What is claimed is:

1. An apparatus for closing at least a portion of a doorway opening in a wall between a cold space on one side of the wall and a warm space on the other side of the wall, the apparatus comprising:
a front resilient layer;
a back resilient layer;
a central insulating layer comprising a plurality of rigid insulating pieces aligned in tile pattern sandwiched between the front and back resilient foam layers;
a resilient sheet covering the front and back resilient layers and interposed central insulating layer, forming a resilient insulating panel; and
a roller structure attached to the resilient insulating panel.

2. The apparatus of claim 1, wherein the roller structure comprises a horizontally moving, top roller structure, further comprising:
a retention mechanism positioned to urge a lower portion of the resilient insulating panel into sealing contact with one vertical side of the doorway.

3. The apparatus of claim 2, wherein the wall proximate to the doorway opening further comprises a trailing edge side casing, the retention mechanism comprises a floor mounted guide spaced apart from the wall adjacent to the doorway opening, the floor mounted guide comprising:
a horizontal flange attached to the trailing edge side casing extending horizontally proximate to a floor having an outward upwardly turned surface;
a wedge surface inwardly directed from the outward upwardly turned surface of the trailing edge guide; and
an outward and aft angled bracket attached to a trailing surface of the door panel positioned to engage the wedge surface as the door panel approaches full closing travel to urge the door panel into sealing contact with the door frame.

4. The apparatus of claim 2, further comprising a sensor positioned to sense the resilient insulating panel residing displaced outside of the retention mechanism, the apparatus further comprising a door positioning system coupled between the wall and the top roller structure and operably configured to horizontally translate the resilient insulating panel, the door positioning system responsive to a sensed displaced resilient insulating panel to horizontally translate the resilient insulating panel sufficient to align a leading edge of the resilient insulating panel with an entry into the retention mechanism.

5. The apparatus of claim 2, wherein the door positioning system is further operably configured to recluse the resilient insulating panel after opening to reset within the retention mechanism.

6. The apparatus of claim 5, wherein the door positioning system is further operably configured to wait for a period of time with the door opened beyond contact with the restraining device allowing the resilient insulating panel to fall back toward the vertical before reclosing.

7. The apparatus of claim 6, wherein the door positioning system is further operably configured to open the door panel in response to a user command to an open position wherein the door panel remains in contact with the restraining device.

8. The apparatus of claim 1, further comprising a magnetic assembly having a first member installed in the wall and a second member installed in a trailing edge of the resilient insulating panel, wherein first and second members magnetically attract each other when in a closed position and thereby maintain the resilient insulating panel into proximity with the wall.

9. The apparatus of claim 8, wherein the first member and second members of the magnetic assembly comprise a ferrous target and a permanent magnet.

10. The apparatus of claim 8, wherein the first member comprises an electromagnet and the second member comprises a ferrous target, the magnetic assembly further comprising a door controller responsive to a user command to open the resilient insulating panel and to deactivate the electromagnet.

11. The apparatus of claim 8, wherein the first member comprises an electromagnet and the second member comprises a permanent magnet, the magnetic assembly further comprising a door controller responsive to a user command to open the resilient insulating panel and to deactivate the electromagnet.

12. The apparatus of claim 8, further comprising a rearwardly projecting flap attached to a trailing edge of the resilient insulating panel and including the second member.

13. An automated door system, comprising:
a doorframe defining an entrance;
a door track mounted across a top portion of the doorframe;
a door panel movably and vertically supported by the door track and comprised of a resilient material for being able to recover from an impact and movable to contact the doorframe and to obstruct at least a portion of the entrance when in a closed position;
a door position sensor operable to sense the door panel in a closed position with a periphery of the door panel registered to the doorframe; and
a door positioning system operably configured to position the door panel to the closed position and to reset the door panel to an open position in response to the door position sensor sensing the door panel no longer being registered to the doorframe indicating impact.

14. The automated door system of claim 13, further comprising a restraining device positioned to urge a lower portion of the door panel into contact with the doorframe.

15. The automated door system of claim 13, wherein the door track includes a lateral extension sufficient for the door panel to open beyond contact with the restraining device, and wherein the door positioning system is further operably configured to reset the door panel by opening the door panel beyond contact with the restraining device and thereafter closing the door panel.

16. The automated door system of claim 15, wherein the door positioning system is further operably configured to wait for a period of time with the door opened beyond contact with the restraining device allowing the door panel to fall back toward the vertical.

17. The automated door system of claim 15, wherein the door positioning system is further operably configured to open the door panel in response to a user command to an open position wherein the door panel remains in contact with the restraining device.

18. A door system, comprising:
a door frame defining an entrance and having a sealing surface and having a recess approaching a trailing edge of the sealing surface;
a door track mounted across a top portion of the door frame;
a door panel supported by the door track for movement between an open position and a closed position with the sealing surface of the door frame; and
a trailing edge guide including a horizontal flange attached to a trailing edge side casing extending horizontally proximate to a floor having an outward upwardly turned surface;
a wedge surface inwardly directed from the outward upwardly turned surface of the trailing edge guide; and
an outward and aft angled bracket attached to a trailing surface of the door panel positioned to engage the wedge surface as the door panel approaches full closing travel to urge the door panel into sealing contact with the door frame.
